(19) United States
(12) Patent Application Publication
(10) Pub. No.: US 2017/0066239 A1
(43) Pub. Date: Mar. 9, 2017

(54) MEMS DEVICE, LIQUID EJECTING HEAD, LIQUID EJECTING APPARATUS, AND MANUFACTURING METHOD OF MEMS DEVICE

(71) Applicant: SEIKO EPSON CORPORATION, Tokyo (JP)

(72) Inventors: Eiju HIRAI, Azumino (JP); Toshiaki HAMAGUCHI, Suwa-gun (JP)

(21) Appl. No.: 15/258,697

(22) Filed: Sep. 7, 2016

(30) Foreign Application Priority Data
Sep. 8, 2015 (JP) 2015-176370

(51) Int. Cl. B41J 2/14; B41J 2/16

(52) U.S. Cl. CPC B41J 2/14209; B41J 2/1607; B41J 2/1631

(57) ABSTRACT

A MEMS device includes a first substrate which has a first electrode and a protective layer that covers the first electrode; a second substrate that is disposed laminated on the first substrate and that has a second electrode that is electrically connected to the first electrode; and a photosensitive adhesive which joins the protective layer and the second substrate, in which a joining surface of the protective layer which is joined by the photosensitive adhesive is flat.

### BACKGROUND

1. Technical Field

The present invention relates to a MEMS device, a liquid ejecting head which is an example of the MEMS device, a liquid ejecting apparatus which is provided with the liquid ejecting head, and a manufacturing method of a MEMS device.

2. Related Art

An ink jet recording head, which is an example of a Micro Electro Mechanical Systems (MEMS) device, has a flow path forming substrate on a which a pressure generating chamber that retains liquid is formed and a functional element (piezoelectric element) that is provided on one surface side of the flow path forming substrate, generates pressure variation in the liquid within the pressure generating chamber by driving the piezoelectric element, and ejects a liquid droplet from a nozzle that is linked to the pressure generating chamber.

As such a piezoelectric element, an element is suggested with a thin-film shape that is formed by film deposition and photolithography on the flow path forming substrate. It is possible to dispose the piezoelectric elements at high density by using the thin-film shape piezoelectric elements, on the other hand, electrical connection between the piezoelectric elements that are disposed at high density and a driving circuit is difficult.

For example, an ink jet recording head described in JP-A-2014-51008 is provided with a flow path forming substrate on which the pressure generating chamber or piezoelectric element are provided and a driving circuit substrate on which a driving circuit that drives a bump or the piezoelectric element is provided, and the driving circuit and the piezoelectric element are electrically connected via the bump. Furthermore, a plurality of bumps are disposed in a peripheral region of the piezoelectric element, and a sealing material (adhesive) is filled between the plurality of bumps.

It is possible to easily electrically connect the piezoelectric element and the driving circuit that are disposed at high density by using the bump to connect the driving circuit and the piezoelectric element. Furthermore, the adhesive is disposed between the flow path forming substrate and the driving circuit substrate, and the piezoelectric element is blocked from the atmosphere and is moisture proofed.

However, there are concavities and convexities in a part which is joined by the adhesive. Due to the concavities and convexities, there is a concern that joining strength of the adhesive with respect to the flow path forming substrate and the driving circuit substrate (joining strength of the driving circuit substrate and the flow path forming substrate) is lowered. When the joining strength of the driving circuit substrate and the flow path forming substrate is lowered, there is a concern that electrical connection between the bump and the piezoelectric element (functional element) is not stable, and furthermore, moisture proofing with respect to the piezoelectric element (functional element) is insufficient.

Furthermore, even in the MEMS device other than the ink jet recording head, for example, a surface acoustic wave (SAW) oscillator, the same problem exists. A SAW oscillator described in JP-A-2009-117544 is an example of the MEMS device, and is provided with a semiconductor substrate and a sealing substrate on which a SAW element (surface acoustic wave device (functional element)) or a bump is provided, the high-density packaging is realized by the bump, and surface oxidation or binding of water molecules of the SAW element (functional element) is suppressed by a sealing member (adhesive) which joins the semiconductor substrate and the sealing substrate. For example, when there are concavities and convexities in a part which is joined by the adhesive, there is a concern that the joining strength of the adhesive is reduced with respect to the semiconductor substrate and the sealing substrate, and the suppression of surface oxidation or binding of water molecules of the SAW element (functional element) is insufficient.

### SUMMARY

The invention can be realized in the following aspects or application examples.

### Application Example 1

According to this application example, there is provided a MEMS device including a first substrate which has a first electrode and a protective layer that covers the first electrode, a second substrate that is disposed laminated on the first substrate and that has a second electrode that is electrically connected to the first electrode, and a photosensitive adhesive which joins the protective layer and the second substrate, in which a joining surface of the protective layer which is joined by the photosensitive adhesive is flat.

Assuming a case in which there are concavities and convexities where the joining surface of the protective layer which is joined by the photosensitive adhesive is not flat and fluidity of the photosensitive adhesive is low, there is a concern that the photosensitive adhesive tends not to flow so as to cover the concavities and convexities of the joining surface of the protective layer, a gap (cavity) is formed between the photosensitive adhesive and joining surface of the protective layer, and the joining strength of the photosensitive adhesive and the protective layer is lowered.

In the MEMS device according to this application example, since the joining surface of the protective layer which is joined by the photosensitive adhesive is flat, even in a case in which fluidity of the photosensitive adhesive is low, a gap (cavity) tends not to be formed between the photosensitive adhesive and joining surface of the protective layer, and it is possible to increase joining strength of the protective layer and the photosensitive adhesive in comparison to case where the joining surface of the protective layer which is joined by the photosensitive adhesive is not flat. Accordingly, it is possible to favorably join the protective layer (first substrate) and the second substrate using the photosensitive adhesive.

### Application Example 2

In the MEMS device according to the application example, it is preferable for the first electrode to be electrically connected to the second electrode via a bump electrode that is formed on the surface on the opposite side from the first electrode side of the protective layer.

The first electrode of the first substrate is electrically connected to the second electrode of the second substrate via the bump electrode that is formed on the surface on the opposite side from the first electrode side of the protective layer. Since the protective layer (first substrate) and the second substrate are favorably joined by the photosensitive adhesive, the bump electrode is stably electrically connected to both the first electrode and the second electrode in comparison to a case where joining of the protective layer (first substrate) and the second substrate is unstable. Accordingly, it is possible to stably electrically connect the first electrode and the second electrode via the bump electrode.

### Application Example 3

In the MEMS device according to the application example, it is preferable for the first substrate to include a driving circuit.

When the driving circuit is formed on the first substrate and the driving circuit is built in to the first substrate, it is possible to thin the MEMS device in comparison to a configuration in which the substrate on which the driving circuit is formed on the first substrate is externally attached (mounted).

### Application Example 4

According to this application example, there is provided a liquid ejecting head that is the MEMS device in the described above application example, in which it is preferable for the second substrate to include a piezoelectric element that is electrically connected to the second electrode and generates pressure variation in liquid within a pressure generating chamber.

The MEMS device in the described above application example is a liquid ejecting head, in which the second substrate is provided with a piezoelectric element that is electrically connected to the second electrode. Then, the piezoelectric element which is provided on the second substrate is stably electrically connected to the first electrode of the first substrate via the second electrode and the bump electrode. Accordingly, it is possible to provide the liquid ejecting head which stably supplies a driving signal from the first substrate side to the piezoelectric element and in which the piezoelectric element is stably operated.

### Application Example 5

In the liquid ejecting head according to the application example, it is preferable for the photosensitive adhesive to be formed to enclose the piezoelectric element.

The photosensitive adhesive is formed to enclose the piezoelectric element. In other words, the piezoelectric element is enclosed by the photosensitive adhesive, and infiltration of external moisture (humidity) is suppressed. Accordingly, it is possible to provide the liquid ejecting head with high reliability that suppresses deterioration of the piezoelectric element due to infiltration of the external moisture (humidity).

### Application Example 6

According to this application example, there is provided a liquid ejecting apparatus including the liquid ejecting head in the described above application example.

The liquid ejecting head according to this application example stably operates and has high reliability. Accordingly, the liquid ejecting apparatus that is provided with the liquid ejecting head in the described above application example also stably operates and has high reliability.

### Application Example 7

According to this application example, there is provided a manufacturing method of a MEMS device including a first substrate that has the protective layer, a second substrate that is disposed laminated on the first substrate, and a photosensitive adhesive which joins the protective layer and the second substrate, the manufacturing method including forming the protective layer on the first substrate and carrying out a process for flattening, coating the second substrate with the photosensitive adhesive and patterning by photolithography, and curing in a state in which the photosensitive adhesive abuts the flat joining surface of the protective layer.

In the manufacturing method of a MEMS device according to this application example, the protective layer is formed on which the process for flattening is carried out on the first substrate, and the joining surface of the photosensitive adhesive of the protective layer is flat.

Furthermore, the second substrate is coated with the photosensitive adhesive (photosensitive adhesive with high fluidity) with a liquid form, microfabrication is carried out by photolithography, and the photosensitive adhesive is formed with low photosensitivity that is joined to the second substrate.

When the second substrate is coated with the photosensitive adhesive with high fluidity, even if the second substrate has concavities and convexities, since the photosensitive adhesive with the high fluidity flows and covers the concavities and convexities, and a gap (cavity) tends not to be formed between the photosensitive adhesive and the second substrate, it is possible to increase joining strength of the photosensitive adhesive and the second substrate in comparison to a case in which the gap (cavity) is formed between the photosensitive adhesive and the second substrate. Additionally, since the photosensitive adhesive with low fluidity that is microfabricated by photolithography is formed on the second substrate, even in the MEMS device that has, for example, high definition and high density, it is possible to form the photosensitive adhesive with a predetermined shape at a predetermined position with high precision.

Consequently, microfabrication is carried out with high precision, and it is possible to form the photosensitive adhesive with low fluidity with high joining strength on the second substrate.

Furthermore, the photosensitive adhesive is joined to the protective layer of the first substrate by curing in a state in which the photosensitive adhesive with low fluidity abuts with the flat joining surface of the protective layer of the first substrate. Even in a case in which the fluidity of the photosensitive adhesive is low, since the joining surface of the photosensitive adhesive of the protective layer is flat, in comparison to a case in which the joining surface of the photosensitive adhesive of the protective layer is not flat, a gap (cavity) tends not to be formed between the photosensitive adhesive and the joining surface of the photosensitive adhesive of the protective layer, and in comparison to a case in which a gap (cavity) is formed between the photosensitive adhesive and the joining surface of the photosensitive adhesive of the protective layer, it is possible to increase joining strength of the photosensitive adhesive and the protective layer.

Accordingly, the method is favorably applied to the MEMS device that has high definition and high density, and it is possible to form the photosensitive adhesive that is favorably joined to both the protective layer (first substrate) and the second substrate. In other words, since the protective layer (first substrate) and the second substrate are favorably joined by the photosensitive adhesive, it is possible to suppress defects such as the piezoelectric element deteriorating due to joining of the protective layer (first substrate) and the second substrate being unstable, and moisture infiltrating from between the protective layer (first substrate) and the second substrate, or defects such as a driving signal that is supplied to the piezoelectric element being unstable and operation of the piezoelectric element being unstable.

### BRIEF DESCRIPTION OF THE DRAWINGS

The invention will be described with reference to the accompanying drawings, wherein like numbers reference like elements.

FIG. 1 is a schematic view illustrating a configuration of a printer according to Embodiment 1.

FIG. 2 is a schematic sectional view illustrating a configuration of a recording head according to Embodiment 1.

FIG. 3 is a process flow illustrating a manufacturing method of the recording head according to Embodiment 1.

FIG. 4 is a schematic sectional view illustrating a state of after step S1 is over.

FIG. 5 is a schematic sectional view illustrating a state of after step S2 is over.

FIG. 6 is a schematic sectional view illustrating a state of after step S11 is over.

FIG. 7 is a schematic sectional view illustrating a state of after step S21 is over.

FIG. 8 is a schematic sectional view illustrating a configuration of a recording head according to Embodiment 2.

### DESCRIPTION OF EXEMPLARY EMBODIMENTS

Embodiments of the invention will be described below with reference to the drawings. The present embodiment illustrates an aspect of the invention, but is not limited to the invention, and is able to be arbitrarily modified within the scope of the technical concept of the invention. In addition, in each of the drawings described below, the scale of each layer and each part is different from the actual size in order for the sizes of each layer and each part to be to the extent so as to be recognizable in the drawings.

### Embodiment 1

### Summary of Printer

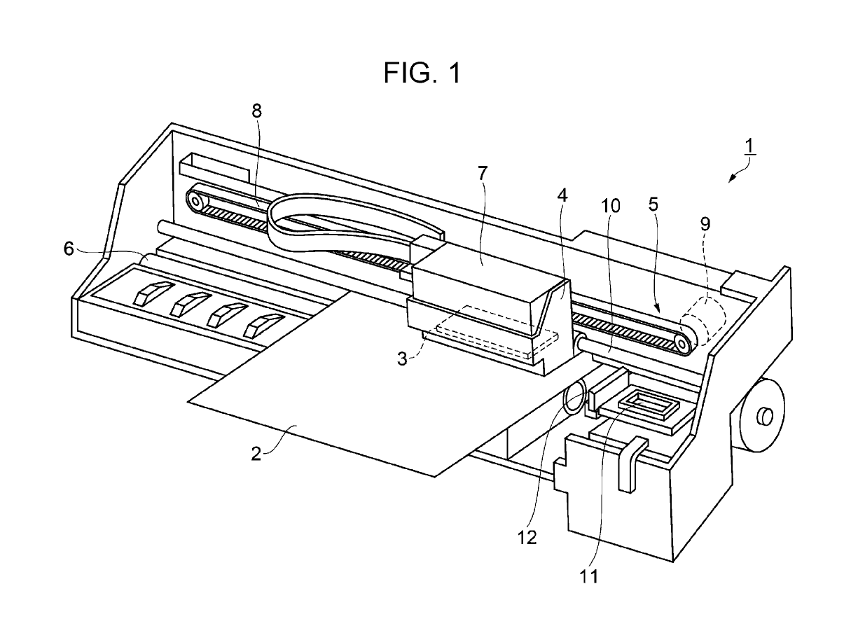

FIG. 1 is a schematic view illustrating a configuration of an ink jet recording apparatus (hereinafter, referred to as printer) according to Embodiment 1. To begin with, with reference to FIG. 1, a summary of a printer 1 that is an example of a “liquid ejecting apparatus” will be described.

The printer 1 according to the embodiment is an apparatus that ejects ink that is an example of “liquid” on a recording medium 2 such as recording paper and performs recording (printing) of an image or the like on the recording medium 2.

As shown in FIG. 1, the printer 1 is provided with a recording head 3, a carriage 4 to which the recording head 3 is attached, a carriage moving mechanism 5 which moves the carriage 4 in a main scanning direction, a transport mechanism 6 which transfers the recording medium 2 in a sub-scanning direction, and the like. Here, the ink is retained in an ink cartridge 7 which acts as a liquid supply source. The ink cartridge 7 is mounted so as to be attachable and detachable with respect to the recording head 3.

Note that, the recording head 3 is an example of the “Micro Electro Mechanical Systems (MEMS) device” and the “liquid ejecting head”. Furthermore, there may be a configuration in which the ink cartridge is disposed at a printer main body side, and ink is supplied from the ink cartridge to the recording head 3 through an ink supply tube.

The carriage moving mechanism 5 is provided with a timing belt 8 and is driven by a pulse motor 9 such as a DC motor. When the pulse motor 9 is operated, the carriage 4 is guided on a guide rod 10 which is installed in the printer 1 and reciprocally moves in the main scanning direction (width direction of the recording medium 2). The position of the carriage 4 in the main scanning direction is detected by a linear encoder (illustration omitted) that is a type of positional information detecting means. The linear encoder transmits a detection signal, that is, an encoder pulse to a control portion of the printer 1.

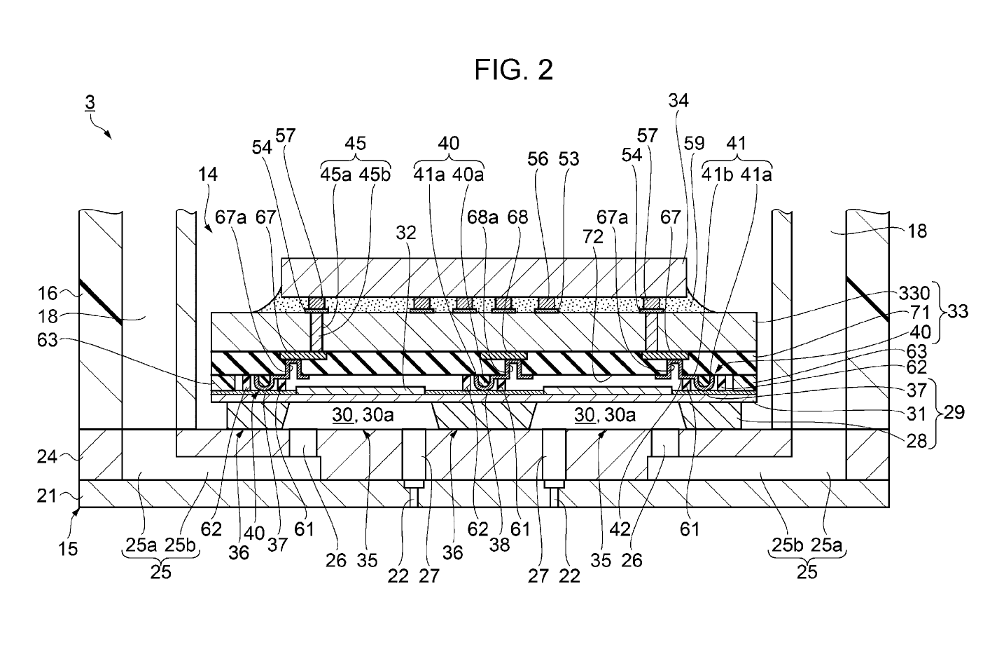

In addition, a home position that is a reference point of a scan of the carriage 4 is set on an end portion region further on the outside than the recording surface within a movement range of the carriage 4. A cap 11 that seals a nozzle 22 (refer to FIG. 2) that is formed on a nozzle surface (nozzle plate 21 (refer to FIG. 2)) of the recording head 3 and a wiping unit 12 that wipes the nozzle surface are disposed in order from the end section side at the home position.

### Recording Head Summary

FIG. 2 is a schematic sectional view illustrating a configuration of a recording head according to the embodiment.

Next, a summary of the recording head 3 will be described with reference to FIG. 2.

As shown in FIG. 2, the recording head 3 has a flow path unit 15, an electronic device 14, and a head case 16. In the recording head 3, the head case 16 is attached in a state in which the flow path unit 15 and the electronic device 14 are laminated.

Hereafter, a direction in which the flow path unit 15 and the electronic device 14 are laminated is described as an up and down direction.

The head case 16 is a box-shaped member made of a synthetic resin and forms a reservoir 18 that supplies ink in each pressure generating chamber 30 to the inner portion of the head case 16. The reservoir 18 is a space in which ink is retained that is common with the plurality of lined up pressure generating chambers 30, and two reservoirs 18 are formed corresponding to the row of the pressure generating chambers 30 that are lined up in two rows. Note that, an ink introduction path (illustration omitted) that introduces ink from the ink cartridge 7 side to the reservoir 18 is formed above the head case 16.

The flow path unit 15 that is joined to the lower surface of the head case 16 has a linking substrate 24 and a nozzle plate 21. The linking substrate 24 is a plate material formed of silicon, and in the embodiment, is manufactured from the silicon single crystal substrate on which a crystal face azimuth on the front surfaces (upper surface and lower surface) is set as a (110) surface. A common liquid chamber 25 in which ink is retained common to each pressure generating chamber 30 that is linked to the reservoir 18 and an individual linking path 26 that supplies ink from the reservoir 18 via the common liquid chamber 25 individually to each pressure generating chamber 30 are formed on the linking substrate 24 by etching. The common liquid chamber 25 is a long space portion along a nozzle row direction and is formed in two rows corresponding to the rows of the pressure generating chambers 30 that are lined up in two rows. The common liquid chamber 25 is configured from a first liquid chamber 25a that is passed through in a plate thickness direction of the linking substrate 24 and a second liquid chamber 25b which is recessed up to the middle of the plate thickness direction of the linking substrate 24 from the lower surface side toward the upper surface side of the linking substrate 24 and that is formed in a state in which a thin plate portion remains on the upper surface side. A plurality of individual linking paths 26 are formed in the thin plate portion of the second liquid chamber 25b along the arrangement direction of the pressure generating chamber 30 corresponding to the pressure generating chamber 30. The individual linking path 26 is linked to one end portion in the longitudinal direction of the corresponding pressure generating chamber 30 in a state in which the linking substrate 24 and the second substrate 29 are joined.

In addition, the nozzle linking path 27 that is passed through in a plate thickness direction of the linking substrate 24 is formed on the position corresponding to each nozzle 22 of the linking substrate 24. That is, a plurality of nozzle linking paths 27 are formed along the nozzle row direction corresponding to the nozzle row. The pressure generating chamber 30 and the nozzle 22 are linked by the nozzle linking path 27. The nozzle linking path 27 is linked to another end portion (end portion on the opposite side from the individual linking path 26 side) in the longitudinal direction of the corresponding pressure generating chamber 30 in a state in which the linking substrate 24 and the second substrate 29 are joined.

The nozzle plate 21 is a substrate formed of silicon (for example, a silicon single crystal substrate) that is joined to the lower surface of the linking substrate 24 (surface on the opposite side from the second substrate 29 side). In the embodiment, an opening on the lower surface side of the space that is the common liquid chamber 25 is sealed by the nozzle plate 21. In addition, a plurality of nozzles 22 are established in a straight line shape (row shape) on the nozzle plate 21. In the embodiment, the nozzle rows are formed in two rows which correspond to the rows of the pressure generating chamber 30 which are formed in two rows. The plurality of established nozzles 22 (nozzle rows) are provided at equal gaps along the sub-scanning direction which is orthogonal to the main scanning direction at a pitch (for example, 600 dpi) corresponding to the dot formation density from the nozzle 22 on one end side up to the nozzle 22 on the other end side.

Note that, the nozzle plate is joined to a region separated from the common liquid chamber to the inside in the linking substrate, and it is also possible to seal the opening on the lower surface side of the space that is the common liquid chamber using, for example, a member such as a compliance sheet that has flexibility. By doing this, the nozzle plate is able to reduce the size of the nozzle plate as much as possible.

The electronic device 14 is a piezoelectric device with a thin film shape that functions as an actuator that generates pressure variation in ink within each pressure generating chamber 30. That is, in the electronic device 14, pressure variation in ink within each pressure generating chamber 30 is generated and ink is ejected from the nozzle 22 that is linked to each pressure generating chamber 30. The electronic device 14 has a configuration in which the second substrate 29, adhesives 61, 62, and 63, the first substrate 33, and a driving IC 34 are set in units laminated in order. In other words, in the electronic device 14, the second substrate 29 and the first substrate 33 that has the driving IC 34 are joined by the adhesives 61, 62, and 63.

Note that, the adhesives 62 and 63 are examples of a “photosensitive adhesive”.

The second substrate 29 is disposed laminated on the first substrate 33, and has the pressure generating chamber forming substrate 28, the vibration plate 31, and the piezoelectric element 32.

The pressure generating chamber forming substrate 28 is a hard plate material formed of silicon, and is manufactured from the silicon single crystal substrate on which a crystal face azimuth on the front surfaces (upper surface and lower surface) is set as a (110) surface. The pressure generating chamber forming substrate 28 has a through port 30a that forms the pressure generating chamber 30. The through port 30a is formed by carrying out anisotropic etching on the silicon single crystal substrate of the face azimuth (110) in the plate thickness direction. The through port 30a is a space (hollow portion) which forms the pressure generating chamber 30.

The vibration plate 31 is a member with a thin film shape which has elasticity, and is formed on the upper surface (surface on the opposite side from the linking substrate 24 side) of the pressure generating chamber forming substrate 28. The vibration plate 31 is configured from an elastic film made from silicon oxide that is formed on the upper surface of the pressure generating chamber forming substrate 28 and an insulation film made from zirconium oxide that is formed on the elastic film. The vibration plate 31 seals an opening on the upper side of the through port 30a of the pressure generating chamber forming substrate 28.

In addition, an opening on the lower side of the through port 30a of the pressure generating chamber forming substrate 28 is sealed by the linking substrate 24. Then, the through port 30a (hollow portion) that is sealed by the vibration plate 31 and the linking substrate 24 is the pressure generating chamber 30. The pressure generating chamber 30 is formed in two rows which correspond to the nozzle rows which are formed in two rows. The pressure generating chamber 30 is a long hollow portion (space) in a direction orthogonal to the nozzle row direction, the individual linking path 26 is linked to one end portion in the longitudinal direction, and the nozzle linking path 27 is linked to the other end portion.

A region which corresponds to the pressure generating chamber 30 in the vibration plate 31 (region in which the vibration plate 31 and the pressure generating chamber forming substrate 28 do not contact) functions as a displaced portion that is displaced by the vibration plate 31 in a direction that is far from the nozzle 22 or in a direction that is close accompanying displacement of the piezoelectric element 32. That is, a region which corresponds to the pressure generating chamber 30 in the vibration plate 31 (region in which the vibration plate 31 and the pressure generating chamber forming substrate 28 do not contact) is a driving region 35 in which displacement of the vibration plate 31 is permissible. Meanwhile, a region which is separated from the pressure generating chamber 30 in the vibration plate 31 (region in which the vibration plate 31 and the pressure generating chamber forming substrate 28 contact) is a non-driving region 36 in which displacement of the vibration plate 31 is inhibited.

In the driving region 35, the piezoelectric element 32 is formed on the surface on the opposite side from the pressure generating chamber forming substrate 28 of the vibration plate 31. In detail, a lower electrode layer (individual electrode), a piezoelectric body layer, and an upper electrode layer (common electrode) are laminated in order on the surface on the opposite side from the pressure generating chamber forming substrate 28 side of the vibration plate 31 in the driving region 35 and the piezoelectric element 32 is formed. The piezoelectric element 32 is a piezoelectric element of a so-called deflection mode, and changes shape of the vibration plate 31 by deflection. When an electric field according to a potential difference between the lower electrode layer and the upper electrode layer is applied to the piezoelectric body layer, the piezoelectric element 32 is displaced in the direction that is far from the nozzle 22 or in a direction that is close.

The lower electrode layer which configures the piezoelectric element 32 forms the individual electrode 37 that extends up to the non-driving region 36 more on the outside than the piezoelectric element 32, and is electrically connected to the corresponding bump electrode 40. In the lower electrode layer of the piezoelectric element 32 that extends up to the non-driving region 36, a part which contacts the bump electrode 40 is the individual electrode 37, and there is an individual wiring between a part which configures the piezoelectric element 32 and a part which forms the individual electrode 37.

Note that, the individual electrode 37 is an example of the “second electrode”.

The upper electrode layer which configures the piezoelectric element 32 forms the common electrode 38 that extends up to the non-driving region 36 between rows of the piezoelectric element 32, and is electrically connected to the corresponding bump electrode 40. In the upper electrode layer of the piezoelectric element 32 that extends up to the non-driving region 36, a part which contacts the bump electrode 40 is the common electrode 38, and there is a common wiring between a part which configures the piezoelectric element 32 and a part which forms the common electrode 38.

Note that, the common electrode 38 is an example of the “second electrode”.

Furthermore, in the longitudinal direction of the piezoelectric element 32, the individual electrode 37 is formed further on the outside than the piezoelectric element 32, and the common electrode 38 is formed inside. In addition, in the embodiment, the common electrode 38 that extends from the piezoelectric element 32 row on one side and the common electrode 38 which extends from the piezoelectric element 32 row on the other side are electrically connected by the common wiring.

The first substrate 33 is disposed between the second substrate 29 and the driving IC 34, and is a relay substrate (wiring board) which supplies a signal of the driving IC 34 to the second substrate 29. The first substrate 33 has a base material 330 that is made from a silicon single crystal substrate and a wiring, electrode, or the like which are formed on the base material 330.

An electrode 67 which is electrically connected to the individual electrode 37 of the second substrate 29 and an electrode 68 which is electrically connected to the common electrode 38 of the second substrate 29 are formed on the lower surface of the base material 330 (surface on the second substrate 29 side). A plurality of electrodes 67 are formed along the nozzle row direction corresponding to the piezoelectric element 32.

The electrodes 67 and 68 are examples of the “first electrode”.

The electrodes 67 and 68 are covered by the protective layer 71. The protective layer 71 is configured, for example, by silicon oxide, and has an opening 67a which exposes a portion of the electrode 67 and an opening 68a which exposes a portion of the electrode 68. The surface 72 on the opposite side from the side which covers the electrodes 67 and 68 of the protective layer 71 is subjected to the process for flattening and becomes flat.

Note that, the surface 72 of the protective layer 71 is an example of the “joining surface of the protective layer”.

The bump electrode 40 is formed on the surface 72 of the protective layer 71 (surface 72 on the opposite side from the electrodes 67 and 68 side of the protective layer 71). The bump electrodes 40 are disposed at positions that respectively correspond to the individual electrode 37 and the common electrode 38 of the second substrate 29. The bump electrode 40 is configured by an inside resin 40a which has elasticity and a conductive film 41 which covers the inside resin 40a. As the inside resin 40a, for example, it is possible to use a resin such as a polyimide resin. For the conductive film 41 it is possible to use a laminate layer and the like in which an elemental metal, an alloy, a metal silicide, and a metal nitride are laminated. The conductive film 41 has a part 41a (hereinafter referred to as a conductive film 41a) which covers the inside resin 40a and a part 41b (hereinafter referred to as a conductive film 41b) which covers the surface 72 of the protective layer 71 and the openings 67a and 68a.

That is, the bump electrode 40 is configured by the inside resin 40a and the conductive film 41a. The conductive film 41b is a wiring that electrically connects the bump electrode 40 and the electrodes 67 and 68. Since the conductive film 41b is formed to cover the flat surface 72 of the protective layer 71, the conductive film 41b has a flat surface 42 that reflects the shape of the flat surface 72 of the protective layer 71.

In a state in which the bump electrode 40 has elasticity and is elastically deformed (pressed state), the bump electrode 40 is electrically connected to the individual electrode 37 and the common electrode 38 of the second substrate 29. Due to the bump electrode 40 having elasticity, the bump electrode 40 and the individual electrode 37, and the bump electrode 40 and the common electrode 38 are respectively satisfactorily electrically connected in comparison to a case in which the bump electrode 40 does not have elasticity. Accordingly, the electrode 67 of the first substrate 33 is satisfactorily electrically connected to the individual electrode 37 of the second substrate 29 via the bump electrode 40. The electrode 68 of the first substrate 33 is satisfactorily electrically connected to the common electrode 38 of the second substrate 29 via the bump electrode 40.

A plurality (four in the embodiment) of power supply lines 53 which supply power (for example, VDD1 (power source of a low voltage circuit), VDD2 (power source of a high voltage circuit), VSS1 (power source of a low voltage circuit), and VSS2 (power source of a high voltage circuit)) to the driving IC 34 are formed at the center of the upper surface of the base material 330 (surface on the driving IC 34). Each power supply line 53 extends along the nozzle row direction, that is, the longitudinal direction of the driving IC 34, and is connected to an external power source (illustration omitted) and the like via the wiring board (illustration omitted) such as a flexible cable in the end portion in the longitudinal direction. Then, a power supply bump electrode 56 of the corresponding driving IC 34 is electrically connected on the power supply line 53.

An individual connection terminal 54 is formed on the end (region separated outside from the region in which the power supply line 53 is formed) on the upper surface of the base material 330. The individual connection terminal 54 is electrically connected to the individual bump electrode 57 of the driving IC 34, and a signal from the driving IC 34 is input. A plurality of individual connection terminals 54 are formed along the nozzle row direction corresponding to the piezoelectric element 32. The individual connection terminal 54 is electrically connected to the electrode 67 that is formed on the lower surface of the base material 330 via the through wiring 45 that is formed inside the base material 330.

The through wiring 45 is a wiring which relays between the lower surface of the base material 330 and the upper surface of the base material 330, and is configured by a through hole 45a that passes through the base material 330 in the plate thickness direction and a conductor portion 45b that is filled inside the through hole 45a. The conductor portion 45b is configured by, for example, metal such as copper (Cu), tungsten (W), or nickel (Ni).

The driving IC 34 is an IC chip for driving the piezoelectric element 32, and is disposed laminated on the upper surface of the base material 330 (upper surface of the first substrate 33) via the adhesive 59 such as an anisotropically-conductive film (ACF). The power supply bump electrode 56 which is electrically connected to the power supply line 53 and the individual bump electrode 57 which is electrically connected to the individual connection terminal 54 are lined up in plurality along the nozzle row direction on the surface on the first substrate 33 side of the driving IC 34.

The power (voltage) is supplied from the power supply line 53 to the driving IC 34 via the power supply bump electrode 56. Then, the driving IC 34 generates a signal (driving signal or common signal) for individually driving each piezoelectric element 32. The driving signal that is generated by the driving IC 34 is supplied to the lower electrode layer of the piezoelectric element 32 via the individual bump electrode 57, the individual connection terminal 54, the through wiring 45, the electrode 67, the bump electrode 40, and the individual electrode 37. Furthermore, the common signal that is generated by the driving IC 34 is supplied to the upper electrode layer of the piezoelectric element 32 via a wiring (illustration omitted), the electrode 68, the bump electrode 40, and the common electrode 38 that are formed on the base material 330.

The adhesives 61, 62, and 63 are disposed on the non-driving region 36 between the first substrate 33 and the second substrate 29. The adhesives 61, 62, and 63 are joined to the first substrate 33 and the second substrate 29. In other words, the first substrate 33 and the second substrate 29 are joined by the adhesives 61, 62, and 63.

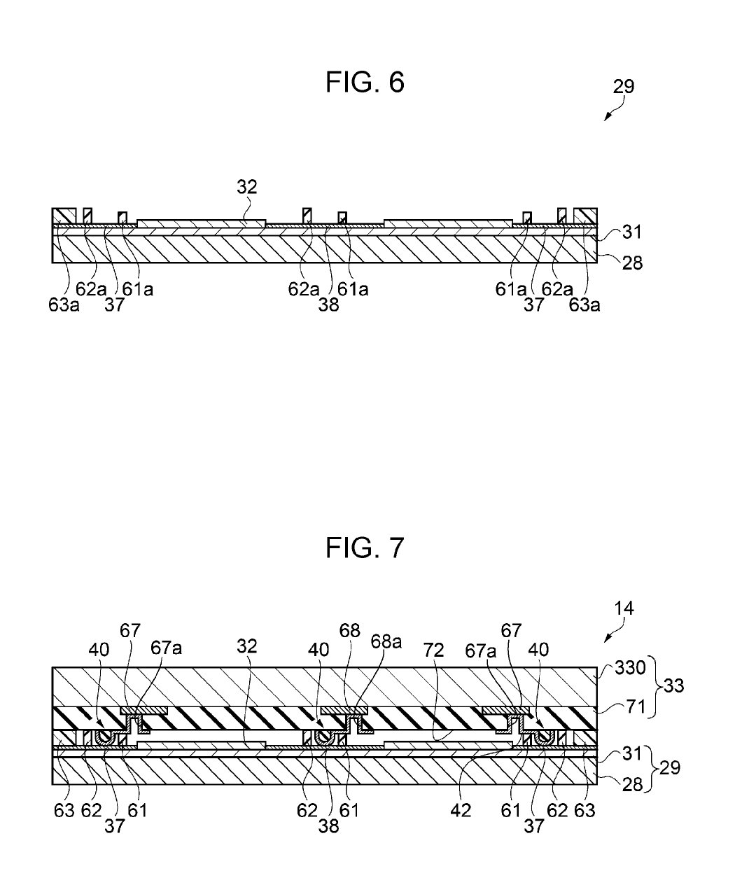

The adhesives 61, 62, and 63 are formed from a resin with resin that has photosensitivity and thermosetablility as the main component such as, for example, an epoxy resin, an acrylic resin, a phenol resin, a polyimide resin, a silicon resin, and a styrene resin. Although described later in detail, a resin solution (photosensitive adhesive) which has photosensitivity and thermosetablility coats the second substrate 29, and adhesives 61a, 62a, and 63a are formed that are temporarily cured on the surface on the first substrate 33 side of the second substrate 29 by patterning by photolithography (refer to FIG. 6). The adhesives 61a, 62a, and 63a which bond and temporarily cure the first substrate 33 are cured in a state of abutting with the first substrate 33, and the adhesives 61, 62, and 63 are formed (refer to FIG. 7).

The adhesives 61 and 62 are disposed close to the bump electrode 40 in a band shape along the nozzle row direction in a state of being separated from the bump electrode 40. As described above, the bump electrode 40 is electrically connected to the individual electrode 37 or the common electrode 38 in a state of being elastically deformed. The adhesives 61 and 62 are separated from the bump electrode 40 by the degree to which the bump electrode 40 is elastically deformed and not interfering with the bump electrode 40.

The adhesive 63 is disposed so as to enclose the piezoelectric element 32 in a peripheral edge portion of the first substrate 33 and the second substrate 29 and has a frame shape. The piezoelectric element 32 is sealed by the first substrate 33, the second substrate 29, and the adhesive 63, and influence of moisture (humidity) on an outer portion is suppressed. In other words, the influence of moisture on the piezoelectric element 32 is suppressed and deterioration of the piezoelectric element 32 due to moisture is suppressed by forming the adhesive 63 that encloses the piezoelectric element 32 between the first substrate 33 and the second substrate 29.

The adhesive 61 is joined to the surface 42 of the conductive film 41b. That is, the adhesive 61 joins the conductive film 41b of the first substrate 33 and the second substrate 29. As described above, since the surface 42 of the conductive film 41b is flat, the joining surface (surface 42) of the conductive film 41b of the first substrate 33 which is joined by the adhesive 61 is flat.

Furthermore, although illustration is omitted in FIG. 2, the adhesive 61 also joins the surface 72 of the protective layer 71. That is, the adhesive 61 joins the protective layer 71 of the first substrate 33 and the second substrate 29. As described above, since the process for flattening the protective layer 71 is carried out and the surface 72 of the protective layer 71 is flat, the joining surface (surface 72) of the protective layer 71 of the first substrate 33 which is joined by the adhesive 61 is flat.

The adhesives 62 and 63 are joined to the surface 72 of the protective layer 71. That is, the adhesives 62 and 63 join the protective layer 71 of the first substrate 33 and the second substrate 29. As described above, since the process for flattening the protective layer 71 is carried out and the surface 72 of the protective layer 71 is flat, the joining surface (surface 72) of the protective layer 71 of the first substrate 33 which is joined by the adhesives 62 and 63 is flat.

In this manner, in the recording head 3, ink from the ink cartridge 7 is introduced into the pressure generating chamber 30 via the ink introduction path, the reservoir 18, the common liquid chamber 25, and the individual linking path 26. Furthermore, the second substrate 29 is electrically connected to the individual electrode 37 and the common electrode 38, and is provided with the piezoelectric element 32 to which pressure variation is generated in ink within the pressure generating chamber 30. In this state, the piezoelectric element 32 is driven by supplying the driving signal from the driving IC 34 to the piezoelectric element 32 of the second substrate 29 via the wiring and electrode that is formed on the first substrate 33, and pressure variation is generated in the pressure generating chamber 30 by driving of the piezoelectric element 32. By using the pressure variation, in the recording head 3, the ink droplet is ejected from the nozzle 22 via the nozzle linking path 27.

### Recording Head Manufacturing Method

Next, the manufacturing method of the recording head 3 according to the embodiment will be described.

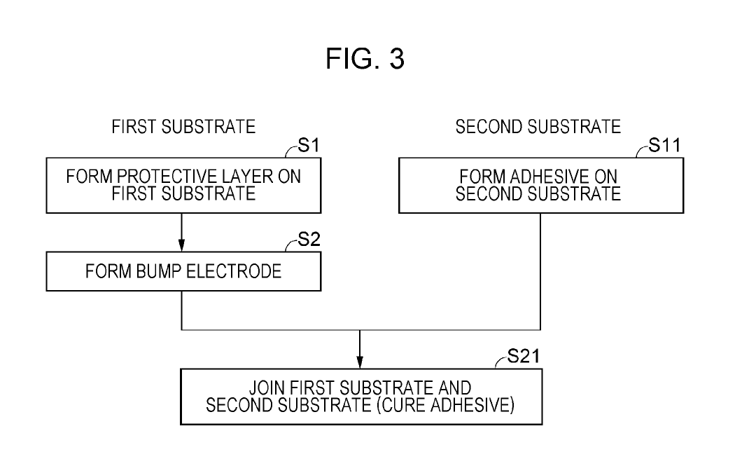

FIG. 3 is a process flow illustrating a manufacturing method of the recording head according to the embodiment.

As shown in FIG. 3, the manufacturing method of the recording head 3 according to the embodiment includes a process (step S1) in which the protective layer 71 is formed on first substrate 33, a process (step S2) in which the bump electrode 40 is formed on the first substrate 33, and a process (step S11) in which the adhesives 61, 62, and 63 are formed on the second substrate 29, and a process (step S21) in which the adhesives 61, 62, and 63 are cured and the first substrate 33 and the second substrate 29 are joined.

Note that, step S1 is an example of “a process in which a protective layer is formed on the first substrate, and a process for flattening is carried out”. Step S11 is an example of “a process in which the photosensitive adhesive coats the second substrate and patterning is carried out by photolithography”. Step S21 is an example of “a process in which the photosensitive adhesive is cured in a state of abutting with the flat joining surface of the protective layer”.

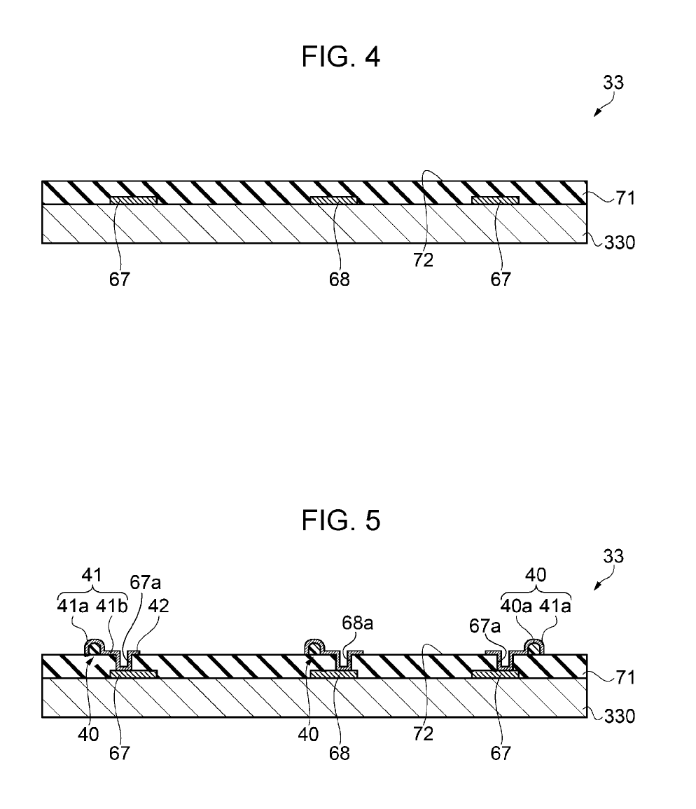

FIG. 4 is a schematic sectional view illustrating a state of the substrate after step S1 is over. FIG. 5 is a schematic sectional view illustrating a state of the substrate after step S2 is over. FIG. 6 is a schematic sectional view illustrating a state of the substrate after step S11 is over. FIG. 7 is a schematic sectional view illustrating a state of the substrate after step S21 is over.

In addition, FIGS. 4 to 7 are diagrams that correspond to FIG. 2, and illustrate a state of the first substrate 33 in FIGS. 4 and 5, FIG. 6 illustrates a state of the second substrate 29, and FIG. 7 illustrates a state of the electronic device 14.

Furthermore, FIGS. 4 and 5 and FIGS. 6 and 7 are opposite in the up and down direction. For example, in FIG. 4, the protective layer 71 is disposed on the upper side of the base material 330, in FIG. 7, the protective layer 71 is disposed on the lower side of the base material 330, and in FIGS. 4 and 7, the disposed position of the protective layer 71 with respect to the base material 330 is opposite up and down. In addition, in FIGS. 4, 6, and 7, illustration is omitted of components of the first substrate 33 (through wiring 45, power supply line 53, individual connection terminal 54, and the like) that are not necessary to describe.

In step S1, for example, silicon oxide which covers the electrodes 67 and 68 is formed by plasma CVD using (tetraethoxysilane) TEOS. The silicon oxide that is formed by plasma CVD using TEOS has superior step coverage, and it is possible to favorably cover the concavities and convexities such as the electrodes 67 and 68. The concavities and convexities that reflect the shape of the electrodes 67 and 68 are formed on the surface on the opposite side from the side which covers the electrodes 67 and 68 of the silicon oxide. Next, with respect to the silicon oxide, for example, the process for flattening is carried out by chemical mechanical polishing (hereinafter referred to as “CMP”), the concavities and convexities that reflect the shape of the electrodes 67 and 68 are eliminated, and as shown in FIG. 4, the protective layer 71 is formed that has the flat surface 72. CMP is able to obtain a flat polishing surface at high speed by balancing a chemical action of a chemical component that is included in polishing liquid and a mechanical action due to relative movement of an abrasive and the base material 330.

Note that, the protective layer 71 may be a multi-layer film that includes silicon oxide and silicon nitride. For example, after the silicon oxide is subjected to film deposition by plasma CVD using TEOS, there may be a configuration in which silicon nitride that is thicker than silicon oxide is subjected to film deposition by plasma CVD, and the silicon nitride is flattened by CMP. For example, there may be a configuration in which silicon nitride is formed by plasma CVD on the silicon oxide that is flattened by CMP.

Silicon nitride is superior in water resistance in comparison to silicon oxide. It is possible to increase water resistance of the protective layer 71 by configuring the protective layer 71 by a multi-layer film that includes silicon oxide and silicon nitride.

In step S2, resin which has photosensitivity is coated, and a precursor resin is formed on the surface 72 of the protective layer 71 by patterning using a photolithography process or an etching process. The inside resin 40a is formed on the surface 72 of the protective layer 71 with rounded corners by melting the precursor resin using a heating treatment. Next, the openings 67a and 68a which expose the electrodes 67 and 68 are formed on the protective layer 71, a metal film is formed which covers the surface 72 of the protective layer 71 and the openings 67a and 68a by vapor deposition, sputtering, or the like, the metal film is patterned by the photolithography process and the etching process, and the conductive film 41 (conductive film 41a and conductive film 41b) is formed to cover the inside resin 40a or the openings 67a and 68a. Thereby, as shown in FIG. 5, the bump electrode 40 is formed that covers the inside resin 40a using the conductive film 41a. The bump electrode 40 is electrically connected to the electrodes 67 and 68 by the conductive film 41b that covers the openings 67a and 68a.

That is, in step S2, the bump electrode 40 is formed that is electrically connected to the electrodes 67 and 68. Furthermore, the protective layer 71 has a part that is covered by the conductive film 41 and the flat surface 72 that is not covered by the conductive film 41. Since the conductive film 41b is formed to cover the flat surface of the protective layer 71, the conductive film 41b has a flat surface 42 that reflects the shape of the flat surface 72 of the protective layer 71.

In step S11, the resin solution with a liquid form that has photosensitivity and thermosetablility coats the second substrate 29, on which the vibration plate 31 and the piezoelectric element 32 are formed. Next, the resin solution with the coated liquid form is temporarily baked (pre-baked) and a resin film with low fluidity is formed. The since the resin solution with the liquid form has high fluidity and the concavities and convexities of the second substrate 29 are favorably covered, the resin film with low fluidity also favorably covers the concavities and convexities of the second substrate 29 and defects such as a gap (cavity) in a part in which the concavities and convexities are formed tend not to be generated. Next, the resin film is patterned by the photolithography process and through post-baking, as shown in FIG. 6, the adhesives 61a, 62a, and 63a with low fluidity are formed on the second substrate 29.

That is, in step S11, the adhesives 61a, 62a, and 63a with low fluidity are formed by patterning the resin film that is formed by coating the resin solution that has photosensitivity and thermosetablility by photolithography. Furthermore, the adhesives 61a, 62a, and 63a with low fluidity are in a state of not being completely cured and have elasticity and an adhesive property.

In step S11, in a case where the adhesives 61, 62, and 63 are formed by curing the adhesives 61a, 62a, and 63a with low fluidity in step S21 which will be described below, the adhesives 61a, 62a, and 63a with low fluidity are formed such that the adhesive 63 encloses the piezoelectric element 32 and the adhesives 61 and 62 do not interfere with the bump electrode 40.

Since defects such as the cavity between the adhesives 61a, 62a, and 63a with low fluidity and the second substrate 29 tend not to be generated, it is possible to increase joining strength between the adhesives 61, 62, and 63 and the second substrate 29 in comparison to a case where defects such as the cavity between the adhesives 61, 62, and 63, which are formed by curing the adhesives 61a, 62a, and 63a with low fluidity, and the second substrate 29 tend not to be generated and there is a cavity between the adhesives 61, 62, and 63 and the second substrate 29.

Furthermore, since the adhesives 61a, 62a, and 63a with low fluidity are formed by patterning the resin film by photolithography, it is possible to form the adhesives 61a, 62a, and 63a with low fluidity with high precision at predetermined positions in comparison to a case of forming, for example, using a dispensing method or a printing method. Accordingly, it is possible to form the adhesives 61, 62, and 63 that are formed by curing the adhesives 61a, 62a, and 63a with low fluidity with high precision at predetermined positions.

It is possible to form a fine high-definition (high density) pattern with superior miniaturization with the method in which the adhesives 61a, 62a, and 63a with low fluidity are formed by patterning by photolithography, in comparison to the method in which the adhesives 61a, 62a, and 63a with low fluidity are formed using the dispensing method or the printing method.

In step S21, the first substrate 33 that is formed through step S1 and step S2 and the second substrate 29 that is formed through step S11 are bonded, the adhesives 62a, and 63a with low fluidity are subjected to heat treatment in a state of being pressed to abut the first substrate 33, the adhesives 62a, and 63a with low fluidity are cured, and the adhesives 61, 62, and 63 are formed that are joined to both the first substrate 33 and the second substrate 29. In other words, the adhesives 62a and 63a with low fluidity are cured and the adhesives 61, 62, and 63 that join the first substrate 33 and the second substrate 29 are formed.

As shown in FIG. 7, in step S21, the adhesive 62 and 63 are joined to the flat surface 72 of the protective layer 71, and the adhesive 61 joins the flat surface 42 of the conductive film 41b and the flat surface 72 of the protective layer 71 (illustration omitted in FIG. 7). Then, the protective layer 71 of the first substrate 33 and the second substrate 29 are joined by the adhesives 61, 62 and 63.

In step S21, the adhesives 62a and 63a with low fluidity are cured in a state of abutting with the flat surface 72 of the protective layer 71, and the adhesives 62 and 63 are formed joined to the flat surface 72 of the protective layer 71. It is assumed that when the joining surface (flat surface 72 of the protective layer 71) of the first substrate 33 on which the adhesives 62a and 63a with low fluidity abut have concavities and convexities, it is difficult for the adhesives 62a and 63a with low fluidity to favorably cover the joining surface of the first substrate 33 which has concavities and convexities, and defects such as a cavity between the adhesives 62a and 63a with low fluidity and the joining surface of the first substrate 33 that has concavities and convexities tend to be generated. In the embodiment, since the joining surface (flat surface 72 of the protective layer 71) of the first substrate 33 on which the adhesives 62a and 63a with low fluidity abut is flat, the adhesives 62a and 63a with low fluidity favorably cover the joining surface of the first substrate 33, and defects such as a cavity between the adhesives 62a and 63a with low fluidity and the joining surface of the first substrate 33 (flat surface 72 of the protective layer 71) tend not to be generated. Accordingly, it is possible to increase joining strength between the adhesives 62 and 63 and the joining surface (flat surface 72 of the protective layer 71) of the first substrate 33 in comparison to a case where the joining surface of the first substrate 33 on which the adhesives 62a and 63a with low fluidity abut has concavities and convexities.

Furthermore, since even in a part in which the adhesive 61 and the surface 72 of the protective layer 71 are joined, the joining surface (surface 72 of the protective layer 71) of the first substrate 33 on which the adhesive 61a with low fluidity abuts is flat, in the same manner, it is possible to increase joining strength between the adhesive 61 and the joining surface (flat surface 72 of the protective layer 71) of the first substrate 33 in comparison to a case where the joining surface of the first substrate 33 on which the adhesive 61a with low fluidity abuts has concavities and convexities.

Furthermore, since even in a part in which the adhesive 61 and the conductive film 41b are joined, the joining surface (surface 42 of the conductive film 41b) of the conductive film 41b on which the adhesive 61a with low fluidity abuts is flat, in the same manner, it is possible to increase joining strength between the adhesive 61 and the joining surface (flat surface 42 of the conductive film 41b) of the first substrate 33 in comparison to a case where the joining surface of the first substrate 33 on which the adhesive 61a with low fluidity abuts has concavities and convexities.

Note that, the adhesive 61 is disposed so as to cover the end portion of the conductive film 41b. Since a step that is equivalent to the film thickness of the conductive film 41b is formed on the end portion of the conductive film 41b, the adhesive 61 is joined to the conductive film 41b and the protective layer 71 to cover the step. The adhesive 61a with low fluidity has elasticity. Accordingly, in a case of abutting the step of the conductive film 41b, the adhesive 61a with low fluidity changes shape following the step of the conductive film 41b, and the defect such as the cavity between the adhesive 61a with low fluidity and the end portion of the conductive film 41b tends not to be generated. Meanwhile, when the adhesive 61a with low fluidity does not have elasticity, since the adhesive 61a with low fluidity tends not to change shape following the step of the conductive film 41b in a case of abutting the step of the conductive film 41b, the defect such as the cavity between the adhesive 61a with low fluidity and the end portion of the conductive film 41b tends to be generated. Accordingly, when the adhesive 61a with low fluidity has elasticity, the defect such as the cavity between the adhesive 61 and the end portion of the conductive film 41b tends not to be generated and it is possible to increase joining strength between the adhesive 61 and the joining surface of the first substrate 33 in the end portion of the conductive film 41b in comparison to a case in which the adhesive 61a with low fluidity does not have elasticity.

Next, anisotropic etching is carried out by, for example, KOH, and the through port 30a that is the hollow portion of the pressure generating chamber 30 is formed on the pressure generating chamber forming substrate 28. In the same manner, the end portion of the pressure generating chamber forming substrate 28 is etched, and the pressure generating chamber forming substrate 28 is smaller than the first substrate 33 (base material 330). Furthermore, the electronic device 14 is manufactured by joining the driving IC 34 via the adhesive 59 on the surface on the opposite side from the second substrate 29 side of the first substrate 33. Furthermore, the recording head 3 is manufactured by joining the electronic device 14, the flow path unit 15, and the head case 16.

It is assumed that when defects such as the cavity are generated between the adhesive 63 and the joining surface of the first substrate 33, there is a concern that joining strength between the adhesive 63 and the joining surface of the first substrate 33 is low, faults such as peeling or cracking tend to be generated in a part in which, for example, the adhesive 63 and the joining surface of the first substrate 33 are joined, moisture infiltrates inside the region that is enclosed by the adhesive 63, the piezoelectric element 32 deteriorates due to moisture, and the reliability of the piezoelectric element 32 is lowered.

Furthermore, when faults such as peeling or cracking are generated in the part in which the adhesive 63 and the joining surface of the first substrate 33 are joined, in a case where anisotropic etching is carried out using the KOH, a defect is generated in which an etchant permeates from the fault and the piezoelectric element 32 deteriorates.

Furthermore, when joining strength between the adhesives 61, 62, and 63 and the joining surface of the first substrate 33 is low, there is a concern that due to mechanical impact, faults such as peeling or cracking tend to be generated in the part in which the adhesives 61, 62, and 63 and the joining surface of the first substrate 33 are joined, the recording head 3 deteriorates, and the reliability of the recording head 3 is lowered.

In the manufacturing method of the recording head 3 according to the embodiment, since the joining strength between the adhesive 63 and the joining surface of the first substrate 33 is increased, moisture tends to infiltrate within the region that is enclosed by the adhesive 63, deterioration of the piezoelectric element 32 due to moisture is suppressed, and it is possible to increase reliability of the piezoelectric element 32 in comparison to a case in which the joining strength between the adhesive 63 and the joining surface of the first substrate 33 is low.

Furthermore, in the manufacturing method of the recording head 3 according to the embodiment, since the joining strength between the adhesives 61, 62, and 63 and the joining surface of the first substrate 33 is increased, faults such as peeling and cracking tend not to be generated in the part in which the adhesives 61, 62, and 63 and the joining surface of the first substrate 33 are joined, deterioration of the recording head 3 is suppressed, and it is possible to increase reliability of the recording head 3 in comparison to a case in which the joining strength between the adhesives 61, 62, and 63 and the joining surface of the first substrate 33 is low.

### Embodiment 2

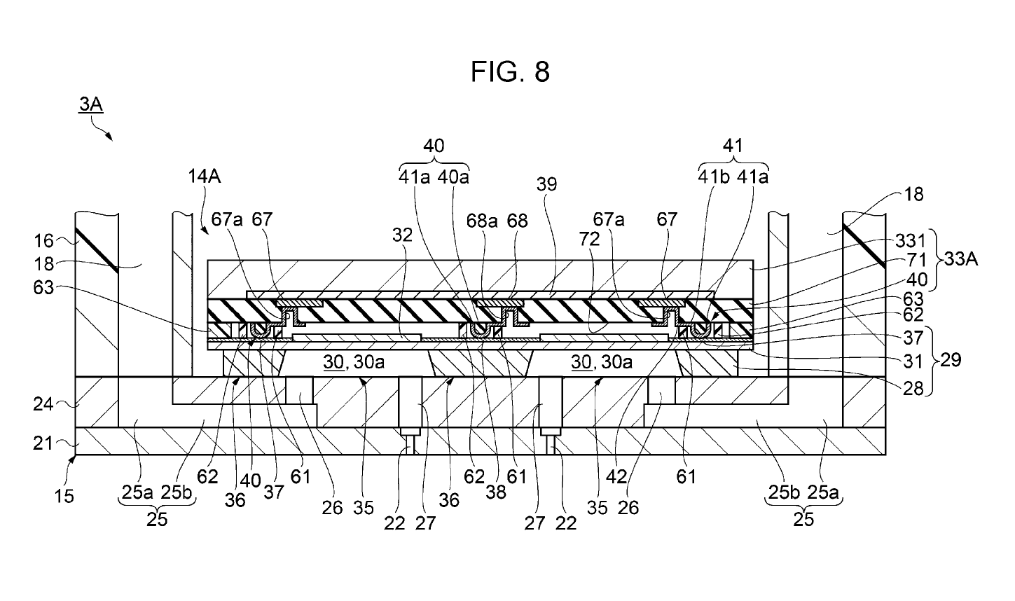

FIG. 8 is a diagram that corresponds to FIG. 2, and is a schematic sectional view illustrating a configuration of a recording head according to Embodiment 2.

In a recording head 3A according to the embodiment, a driving circuit 39 is formed which drives the piezoelectric element 32 on the first substrate 33A. In the recording head 3 according to Embodiment 1, a driving circuit is formed which drives the piezoelectric element 32 on a separate substrate (driving IC 34) from the first substrate 33. In this point, the recording head 3A according to the embodiment and the recording head 3 according to Embodiment 1 are different, and the other configuration is the same in the embodiment and Embodiment 1.

A summary of the recording head 3A according to the embodiment will be described below focusing on differences from Embodiment 1 with reference to FIG. 8. In addition, the same reference numerals are given for the configuration parts which are the same as in Embodiment 1, and overlapping description is omitted.

As shown in FIG. 8, the recording head 3A has the flow path unit 15, an electronic device 14A, and the head case 16.

The electronic device 14A is a MEMS device with a thin film shape that functions as an actuator that generates pressure variation in ink within each pressure generating chamber 30. That is, in the electronic device 14A, pressure variation in ink within each pressure generating chamber 30 is generated and ink is ejected from the nozzle 22 that is linked to each pressure generating chamber 30. The electronic device 14A has a configuration in which the second substrate 29, the adhesives 61, 62, and 63, and the first substrate 33A are set in units laminated in order.

The second substrate 29 is disposed laminated on the first substrate 33A, and has the pressure generating chamber forming substrate 28, the vibration plate 31, and the piezoelectric element 32.

The first substrate 33A is disposed laminated on the second substrate 29, and has a substrate 331 on which the driving circuit 39 is formed that drives the piezoelectric element 32, an electrode (electrode 67, electrode 68, and bump electrode 40) for supplying the signal from the driving circuit 39 to the second substrate 29, and the like.

The substrate 331, for example, is a semiconductor circuit board on which the driving circuit 39 on a p-type silicon substrate (p-type semiconductor substrate) is formed. An N channel transistor is formed by laminating an insulation layer, an electrode layer, or the like in the p-type semiconductor region of the substrate 331. Furthermore, an n-type semiconductor region is formed by carrying out ion implantation of n-type impurities in the p-type semiconductor region of the substrate 331, and a P channel transistor is formed by laminating the insulation layer, the electrode layer, or the like in the n-type semiconductor region. Then, the driving circuit 39 is formed on the substrate 331 by a CMOS transistor that is made from the N channel transistor and the P channel transistor.

An external power source (illustration omitted) and the like is connected to the first substrate 33A via a wiring board (illustration omitted) such as a flexible cable and power (voltage) is supplied to the driving circuit 39. Then, the driving circuit 39 generates a signal (driving signal or common signal) for individually driving each piezoelectric element 32. The driving signal that is generated by the driving circuit 39 is supplied to the lower electrode layer of the piezoelectric element 32 via the electrode 67, the bump electrode 40, and the individual electrode 37. The common signal that is generated by the driving circuit 39 is supplied to the upper electrode layer of the piezoelectric element 32 via the electrode 68, the bump electrode 40, and the common electrode 38.

The adhesives 61, 62, and 63 are joined to the first substrate 33A and the second substrate 29. In other words, the first substrate 33A and the second substrate 29 are joined by the adhesives 61, 62, and 63.

The adhesive 61 is joined to the joining surface of the first substrate 33A (surface 42 of the conductive film 41b and surface 72 of the protective layer 71). Since the joining surface (surface 42 of the conductive film 41b and surface 72 of the protective layer 71) of the first substrate 33A which is joined by the adhesive 61 is flat, it is possible to increase joining strength between the adhesive 61 and the joining surface (surface 42 of the conductive film 41b and surface 72 of the protective layer 71) of the first substrate 33A in comparison to a case where the joining surface of the first substrate 33A which is joined by the adhesive 61 is not flat.

The adhesive 62 and 63 are joined to the joining surface of the first substrate 33A (surface 72 of the protective layer 71). Since the joining surface (surface 72 of the protective layer 71) of the first substrate 33A which is joined by the adhesives 62 and 63 is flat, it is possible to increase joining strength between the adhesives 62 and 63 and the joining surface (surface 72 of the protective layer 71) of the first substrate 33A in comparison to a case where the joining surface of the first substrate 33A which is joined by the adhesives 62 and 63 is not flat.

Since the joining strength between the adhesives 61, 62, and 63 and the joining surface of the first substrate 33A is increased, deterioration of the piezoelectric element 32 and the recording head 3A tends not to be generated, and it is possible to increase reliability of the piezoelectric element 32 and the recording head 3A in comparison to a case in which the joining strength between the adhesives 61, 62, and 63 and the joining surface of the first substrate 33A is low. That is, the recording head 3A according to the embodiment is able to obtain the same effects as the recording head 3 according to Embodiment 1.

Furthermore, in the recording head 3A according to the embodiment, since the driving circuit 39 that drives the piezoelectric element 32 is built in to the first substrate 33A, it is possible to thin the recording head 3A in comparison to a configuration (configuration of Embodiment 1) in which a driving circuit which drives the piezoelectric element 32 is formed on a separate substrate (driving IC 34) from the first substrate 33A.

Furthermore, the invention widely targets a general head, and it is possible to apply the invention, for example, to a recording head such as various ink jet recording heads which are used in an image recording apparatus such as a printer, a color material ejecting head which is used in manufacture of color filters such as a liquid crystal display, an electrode material ejecting head which is used in electrode formation such as an organic EL display or a field emission display (FED), and a biological substance ejecting head which is used in the manufacture of bio chips, and such are included in the technical scope of the invention.

In addition, the invention widely targets a MEMS device, and it is also possible to apply the invention to a MEMS device other than the recording heads 3 and 3A described above. For example, a surface acoustic wave (SAW) device, an ultrasonic device, a motor, a pressure sensor, a pyroelectric element, and a ferroelectric element are examples of the MEMS device, it is possible to apply the invention thereto, and such are included in the technical scope of the invention.

In addition, a finished body that uses the MEMS devices, for example, a liquid ejecting apparatus that uses the recording heads 3 and 3A, a SAW oscillator that uses the SAW device, an ultrasonic sensor that uses the ultrasonic device, a robot that uses the motor as a driving source, an IR sensor that uses the pyroelectric element, a ferroelectric memory that uses the ferroelectric element, and the like are able to be applied to the invention, and such are included in the technical scope of the invention.

The entire disclosure of Japanese Patent Application No: 2015-176370, filed Sep. 8, 2015 is expressly incorporated by reference herein in its entirety.

What is claimed is:

1. A MEMS device comprising:
a first substrate which has a first electrode and a protective layer that covers the first electrode;
a second substrate that is disposed laminated on the first substrate and that has a second electrode that is electrically connected to the first electrode; and
a photosensitive adhesive which joins the protective layer and the second substrate,
wherein a joining surface of the protective layer which is joined by the photosensitive adhesive is flat.

2. The MEMS device according to claim 1,
wherein the first electrode is electrically connected to the second electrode via a bump electrode that is formed on the surface on the opposite side from the first electrode side of the protective layer.

3. The MEMS device according to claim 1,
wherein the first substrate has a driving circuit.

4. A liquid ejecting head that is the MEMS device according to claim 1,
wherein the second substrate is provided with a piezoelectric element that is electrically connected to the second electrode and generates pressure variation in liquid within a pressure generating chamber.

5. A liquid ejecting head that is the MEMS device according to claim 2,
wherein the second substrate is provided with a piezoelectric element that is electrically connected to the second electrode and generates pressure variation in liquid within a pressure generating chamber.

6. A liquid ejecting head that is the MEMS device according to claim 3,
wherein the second substrate is provided with a piezoelectric element that is electrically connected to the second electrode and generates pressure variation in liquid within a pressure generating chamber.

7. The liquid ejecting head according to claim 4,
wherein the photosensitive adhesive is formed to enclose the piezoelectric element.

8. A liquid ejecting apparatus comprising:
the lid ejecting head according to claim 4.

9. A liquid ejecting apparatus comprising:
the lid ejecting head according to claim 5.

10. A liquid ejecting apparatus comprising:
the lid ejecting head according to claim 6.

11. A liquid ejecting apparatus comprising:
the lid ejecting head according to claim 7.

12. A manufacturing method of a MEMS device which includes a first substrate that has the protective layer, a second substrate that is disposed laminated on the first substrate, and a photosensitive adhesive which joins the protective layer and the second substrate, the manufacturing method comprising:
forming the protective layer on the first substrate and carrying out a process for flattening;
coating the second substrate with the photosensitive adhesive and patterning by photolithography; and
curing in a state in which the photosensitive adhesive abuts the flat joining surface of the protective layer.
